(19) United States
(12) Patent Application Publication
(10) Pub. No.: US 2026/0030925 A1
(43) Pub. Date: Jan. 29, 2026

(54) REALTIME FACIAL SENTIMENT ANALYSIS FOR METAHUMAN RESPONSE

(71) Applicants: Chantal Bacon, Palm Beach Gardens, FL (US); David Hawke, Kerrville, TX (US)

(72) Inventors: Chantal Bacon, Palm Beach Gardens, FL (US); David Hawke, Kerrville, TX (US)

(21) Appl. No.: 19/282,454

(22) Filed: Jul. 28, 2025

Related U.S. Application Data
(60) Provisional application No. 63/676,049, filed on Jul. 26, 2024.

(51) Int. Cl. G06V 40/16; G06V 10/75; G06V 10/82

(52) U.S. Cl. CPC G06V 40/174; G06V 10/751; G06V 10/82; G06V 40/165; G06V 40/171

(57) ABSTRACT

A system and method for real-time facial and sentiment detection using a computing system. The system includes a video input module that receives real-time video input from various sources such as webcams, security cameras, and smartphone cameras. The video frames are pre-processed by adjusting the resolution, converting color spaces, and isolating the foreground from the background. A facial detection module employs a convolutional neural network to identify and localize human facial regions within the video frames. Geometric and appearance features are extracted from the localized facial regions by a feature extraction module. A sentiment classification module classifies the extracted features to determine sentiments using a deep learning model. The system also includes a module for API integration, enabling third-party applications to utilize the sentiment recognition results.

### FIELD OF THE INVENTION

This application claims benefit from currently pending U.S. Provisional Application No. 63/676,049 titled “REALTIME FACIAL SENTIMENT ANALYSIS FOR METAHUMAN RESPONSE” and having a filing date of Jul. 26, 2024, all of which is incorporated by reference herein.

### FIELD OF THE INVENTION

The present invention relates to the field of computer vision and machine learning, specifically to systems and methods for real-time facial and sentiment detection using video inputs from various sources for improving interactions within metahuman applications.

### BACKGROUND OF THE INVENTION

Facial and sentiment detection technologies have garnered extensive interest within the realms of human-computer interaction, offering the potential to enhance interactive experiences across diverse applications. These technologies harness computer vision and artificial intelligence (AI) to accurately identify and interpret human emotions based on facial expressions. Human-computer interaction has evolved significantly with the advent of real-time processing capabilities, providing immediate feedback and responses in various contexts such as customer services, entertainment, and healthcare. However, real-time detection and analysis of facial expressions and sentiments pose significant challenges. For a system to accurately detect and analyze facial expressions in real-time, it must be capable of processing high-resolution video input from various sources, such as webcams, security cameras, and smartphone cameras. This requires robust pre-processing modules that can adjust video frames, convert color spaces, and isolate the foreground from the background.

Existing facial and sentiment detection technologies often encounter several limitations, primarily concerning their performance in real-time applications and varying environmental conditions. Many prior systems employ classical image processing and machine learning techniques, which may lack the proficiency to handle complex, real-world scenarios robustly. Standard image processing methods often struggle with variations in lighting, facial occlusions, and diverse camera angles, leading to reduced accuracy in facial recognition and sentiment classification. Furthermore, these systems may face difficulties in real-time processing due to computational inefficiencies, necessitating the development of optimized algorithms and hardware acceleration to meet the performance requirements.

Another critical shortcoming in current technologies pertains to their ability to generalize across different datasets and population demographics. Many existing models are trained on limited datasets, which may not encompass the full spectrum of facial expressions and variations encountered in practical applications. This results in biased performance and diminished reliability when deployed across different geographic and demographic settings. Data augmentation and the use of diverse, comprehensive datasets are essential to enhance model generalization, yet this remains a complex and resource-intensive challenge.

Additionally, the integration of temporal context in sentiment analysis is often inadequate in many existing solutions. While some systems can recognize static facial expressions, they fail to capture the dynamic, sequential nature of human emotions over time. The absence of mechanisms to analyze temporal sequences impedes the accurate interpretation of evolving sentiments, which is crucial for applications involving prolonged interactions, such as virtual assistants and therapy sessions.

What is needed is a system that addresses these limitations by incorporating advanced deep learning models capable of handling real-time facial and sentiment detection with high accuracy. Such a system should leverage pre-processing techniques to improve image quality and mitigate noise disturbances, thereby enhancing the robustness of facial detection under varied conditions. Furthermore, employing diverse and extensive datasets for training, alongside algorithms designed for temporal sequence analysis, can improve model generalization and dynamic sentiment recognition. Integration capabilities through APIs would also facilitate the deployment of this technology across a wide range of applications, ensuring flexibility and scalability.

### BRIEF SUMMARY OF THE INVENTION

The following presents a simplified summary to provide a basic understanding of some novel implementations described herein. This summary is not an extensive overview, and it is not intended to identify key/critical elements or to delineate the scope thereof. Its sole purpose is to present some concepts in a simplified form as a prelude to the more detailed description that is presented later.

The present invention provides for a architecture which enables real-time facial and sentiment detection using a computing system. The system is capable of receiving real-time video input from various sources such as webcams, security cameras, and smartphone cameras. The video frames can be pre-processed by performing scaling to a desired resolution, converting color spaces, and isolating the foreground from the background. The system can employ a convolutional neural network to identify and localize human facial regions within the video frames. It can extract geometric and appearance features from the localized facial regions. The geometric features can include aspect ratios of facial landmarks and distances between specific facial landmarks, while the appearance features include analysis of wrinkles, furrows, and lip curvature, and descriptors for texture representation.

The system can classify the extracted features to determine sentiments using a deep learning model. This model is configured to classify facial expressions into predefined categories such as happiness, sadness, anger, disgust, surprise, fear, and neutrality. The sentiment classification module integrates Action Unit (AU) detection based on the Facial Action Coding System for detailed sentiment inference.

The system can also include a module for API integration, enabling third-party applications to utilize the sentiment recognition results. This real-time facial and sentiment detection system finds applicability in various fields such as security, entertainment, healthcare, and social media platforms, among others.

In terms of method, the system can involve receiving real-time video input, pre-processing the video frames, detecting and localizing human faces within the video frames, extracting geometric and appearance features from the localized facial regions, and classifying the extracted features to determine sentiments. The method can also include the step of integrating the sentiment recognition results into third-party applications via an API.

To the accomplishment of the foregoing and related ends, certain illustrative aspects are described herein in connection with the following description and the annexed drawings. These aspects are indicative of the various ways in which the principles disclosed herein can be practiced and all aspects and equivalents thereof are intended to be within the scope of the claimed subject matter. Other advantages and novel features will become apparent from the following detailed description when considered in conjunction with the drawings.

Aspects and applications of the invention presented here are described below in the drawings and detailed description of the invention. Unless specifically noted, it is intended that the words and phrases in the specification and the claims be given their plain, ordinary, and accustomed meaning to those of ordinary skill in the applicable arts. The inventors are fully aware that they can be their own lexicographers if desired. The inventors expressly elect, as their own lexicographers, to use only the plain and ordinary meaning of terms in the specification and claims unless they clearly state otherwise and then further, expressly set forth the “special” definition of that term and explain how it differs from the plain and ordinary meaning. Absent such clear statements of intent to apply a “special” definition, it is the inventors' intent and desire that the simple, plain and ordinary meaning to the terms be applied to the interpretation of the specification and claims. Aspects and applications of the invention presented here are described below in the drawings and detailed description of the invention.

The inventors are also aware of the normal precepts of English grammar. Thus, if a noun, term, or phrase is intended to be further characterized, specified, or narrowed in some way, then such noun, term, or phrase will expressly include additional adjectives, descriptive terms, or other modifiers in accordance with the normal precepts of English grammar. Absent the use of such adjectives, descriptive terms, or modifiers, it is the intent that such nouns, terms, or phrases be given their plain, and ordinary English meaning to those skilled in the applicable arts as set forth above.

Further, the inventors are fully informed of the standards and application of the special provisions of 35 U.S.C. § 112(f). Thus, the use of the words “function,” “means” or “step” in the Detailed Description or Description of the Drawings or claims is not intended to somehow indicate a desire to invoke the special provisions of 35 U.S.C. § 112(f), to define the invention. To the contrary, if the provisions of 35 U.S.C. § 112(f) are sought to be invoked to define the inventions, the claims will specifically and expressly state the exact phrases “means for” or “step for, and will also recite the word “function” (i.e., will state “means for performing the function of . . . ”), without also reciting in such phrases any structure, material or act in support of the function. Thus, even when the claims recite a “means for performing the function of . . . “or “step for performing the function of . . . ,” if the claims also recite any structure, material or acts in support of that means or step, or that perform the recited function, then it is the clear intention of the inventors not to invoke the provisions of 35 U.S.C. § 112(f). Moreover, even if the provisions of 35 U.S.C. § 112(f) are invoked to define the claimed inventions, it is intended that the inventions not be limited only to the specific structure, material or acts that are described in the preferred embodiments, but in addition, include any and all structures, materials or acts that perform the claimed function as described in alternative embodiments or forms of the invention, or that are well known present or later-developed, equivalent structures, material or acts for performing the claimed function.

### BRIEF DESCRIPTION OF THE DRAWINGS

A more complete understanding of the present invention may be derived by referring to the detailed description when considered in connection with the following illustrative figures. In the figures, like reference numbers refer to like elements or acts throughout the figures.

FIG. 1 shows a logical flow diagram for real-time facial and sentiment detection using AI in accordance to one or more embodiments; and

FIG. 2 shows a system overview for real-time facial and sentiment detection using AI in accordance to one or more embodiments.

Elements and acts in the figures are illustrated for simplicity and have not necessarily been rendered according to any particular sequence or embodiment.

### DETAILED DESCRIPTION

In the following description, and for the purposes of explanation, numerous specific details are set forth to provide a thorough understanding of the various aspects of the invention. It will be understood, however, by those skilled in the relevant arts, that the present invention may be practiced without these specific details. In other instances, known structures and devices are shown or discussed more generally to avoid obscuring the invention. In many cases, a description of the operation is sufficient to enable one to implement the various forms of the invention, particularly when the operation is to be implemented in software. It should be noted that there are many different and alternative configurations, devices, and technologies to which the disclosed inventions may be applied. The full scope of the inventions is not limited to the examples that are described below.

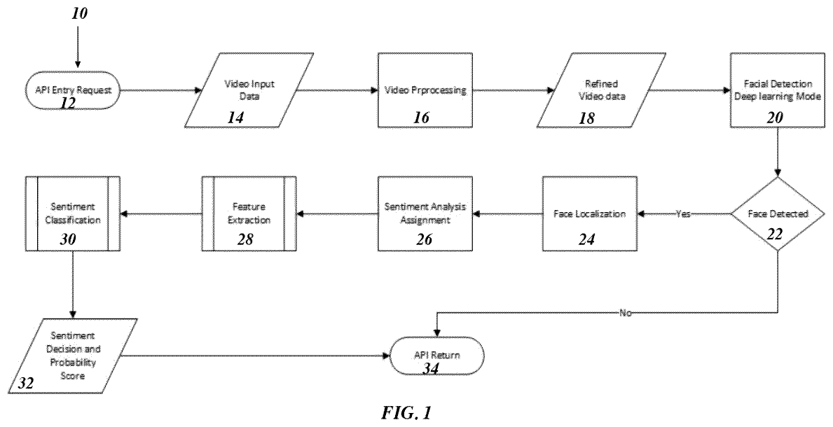

Referring to FIG. 1 a logical flow diagram for a system for real-time facial and sentiment detection for a metahuman response is shown generally at 10. The system for real-time facial and sentiment detection for metahuman response can comprise a video input module configured to receive real-time video input from one or more video sources coupled a computing system. The system can be designed to receive real-time video input from one or more video sources, pre-process the video frames, detect and localize human faces within the video frames, extract geometric and appearance features from the localized facial regions, and classify the extracted features to determine sentiments and then allow for a metahuman response.

At step 12, an application programming interface (“API”) entry request can be made. The API can allow third-party applications to access sentiment recognition functionality. The API can be on such as, for example, a server, a stand-alone computer, portable computer system or the like. The API can be set up on an API service wherein a process pipeline can be implemented such as, scale, color space conversion and background subtraction. The API integration can be configured to enable third-party applications to utilize the sentiment recognition results. This allows the system to be integrated into a wide range of applications, such as video conferencing platforms, social media platforms, and surveillance systems. A facial detection module, a feature extraction module and a sentiment classification module can be implemented on the system. The facial detection module can use a pre-trained CNN model to detect and localize faces. The feature extraction module can extract geometric and appearance features from the detected faces, and the sentiment classification module can use a deep learning model to classify the extracted features into sentiments.

The API can operate on computing infrastructure comprising such as, for example, processors, memory modules, network interfaces, and the like configured to execute specific algorithmic transformations on digital image data. The system can implement a process pipeline that automatically converts input image data through scale normalization algorithms, color space transformation matrices (RGB to HSV conversion using specific mathematical formulas), and background subtraction processes utilizing Gaussian Mixture Models with dynamically updated parameters stored in computer memory. These preprocessing steps can address the challenge of inconsistent lighting conditions and background interference that previously required manual adjustment by human operators.

The computer system's API integration module can execute protocols and data validation routines that can verify incoming requests against stored security parameters, automatically rejecting malformed data packets and preventing system resource exhaustion through algorithmic rate limiting based on computational load metrics. The system can interface with external applications through such as, for example, structured data transmission protocols, enabling automated integration with video processing systems, digital content management platforms, real-time communication software or the like by executing specific software instructions that format and transmit processed results. The facial detection subsystem can implement a trained convolutional neural network model stored in computer memory, executing matrix multiplication operations and activation functions to automatically identify facial regions within digital images and generate coordinate arrays defining bounding rectangles around detected faces which can address the technological problem of inconsistent face detection across varying image conditions that previously required manual region selection. The system can calculate confidence scores through algorithmic probability computations and stores detection results in structured data formats.

At step 14, the system for real-time facial and sentiment detection system can comprise a video input module configured to receive real-time video input from one or more video sources. The video input module can be configured to receive real-time video input from one or more video sources. The video source can be such as, for example, but are not limited to, webcams, security cameras, smartphone cameras, embedded systems, or the like. The video input module can be designed to handle a variety of video formats and resolutions, making it versatile and adaptable to a wide range of use cases. The video input module can capture real-time video streams from the video source, which can comprise initializing the video capture device or stream URL and continuously capture each frame from the video source.

The video input processing module can executes automatic device enumeration algorithms to detect and establish communication protocols with heterogeneous video capture hardware which can be such as, for example, webcams with USB interface specifications, IP-based security cameras utilizing RTSP streaming protocols, smartphone cameras accessed through mobile SDK interfaces, embedded camera systems communicating via I2C or SPI bus protocols, or the like. The system can negotiate optimal capture parameters by executing codec detection routines and bandwidth measurement algorithms stored in computer memory, addressing the technical challenge of manual device configuration that previously caused processing delays and resource conflicts. The video input module can implement technical processes for handling diverse video data formats through automated codec detection and transcoding operations that convert incoming video streams into standardized pixel array formats stored in computer memory buffers. The system can execute resolution scaling algorithms using bilinear or bicubic interpolation mathematical functions to normalize varying input dimensions (720p, 1080p, 4K) into consistent processing formats, solving the technological problem of format incompatibility that previously required manual preprocessing. Buffer management algorithms can automatically allocate and deallocate memory segments based on calculated frame size requirements and processing throughput metrics.

In certain embodiments, the real-time video capture subsystem can execute continuous frame acquisition processes by having at least one circular buffer data structure in computer memory and timestamp synchronization algorithms that maintain consistent frame intervals measured in milliseconds. The system can initialize video capture hardware through device driver API calls that can such as, for example, configure camera sensors, adjust exposure parameters algorithmically based on luminance measurements, establish data transfer protocols with calculated bandwidth allocation, or the like. Frame capture operations can execute pixel data extraction algorithms that read sensor data into memory arrays with automatic error detection and correction protocols.

The continuous frame processing pipeline can have a multi-threaded execution routine that can separate video capture operations from analysis processing through producer-consumer queue data structures stored in shared memory segments. The system can execute frame rate stabilization algorithms that can such as, for example automatically adjust capture timing based on processing load calculations, preventing buffer overflow conditions, maintaining real-time performance through dynamic resource allocation or the like. Stream URL initialization procedures execute network protocol handshaking and authentication sequences for remote video sources, automatically establishing persistent connections with reconnection logic that handles network interruptions without manual intervention.

In embodiments, quality assurance algorithms can continuously monitor captured frame data for technical defects including such as, for example, pixel corruption, synchronization errors, signal degradation, or the like by executing statistical analysis functions on pixel intensity distributions and frame timing measurements. The system can automatically applies noise reduction filters using mathematical convolution operations and implements automatic gain control through histogram equalization algorithms that optimize image quality for subsequent facial detection processing, solving the technological problem of inconsistent video quality that previously degraded detection accuracy.

At step 16, a pre-processing module can be configured to adjust video frames by performing such as, for example, scaling to a desired resolution, converting color spaces, isolating the foreground from the background, normalization, histogram equalization, denoising, frame differencing, or the like. Pre-processing the video frames can improve the accuracy and the efficiency of facial and sentiment detection. Scaling can adjust the size of the video frames to a consistent resolution, which can improve the processing speed and ensure the neural network receives input of the appropriate size. The scaling can involve resizing the frame to a fixed resolution and maintain the aspect ratio to prevent distortion of the image. The scaling process ensures that the video frames are of a consistent size, which is crucial for the subsequent facial detection and sentiment analysis processes. The color space conversation can convert the video frames from one color space to another, such as, for example, RGB to grayscale.

Isolating the foreground from the background can reduce the amount of data processed and focus the analysis on relevant regions which can be such as, for example, static background subtraction, dynamic background subtraction or the like. The color space conversion process involves converting the RGB color space to grayscale or HSV color space. This conversion can simplify the video frames and reduces computational complexity. The pre-processing module can also perform background subtraction to isolate the foreground from the background which can help focus the system's attention on the relevant parts of the video frames, namely the human faces.

In embodiments, the denoising algorithms can remove unwanted noise artifacts from video frames that may result from such as, for example, sensor limitations, compression artifacts, transmission errors and the like. The denoising module can implement various filtering techniques including such as, for example, Gaussian filtering for random noise removal, median filtering for impulse noise suppression, bilateral filtering for edge-preserving smoothing, non-local means denoising for texture preservation, wavelet-based denoising for multi-scale noise reduction or the like. The choice of denoising algorithm and parameters can be automatically selected based on detected noise characteristics and content analysis of the video frames. The frame differencing can calculate the pixel-wise differences between consecutive frames to identify regions of motion or change within the video sequence wherein the temporal analysis enables the system to focus processing resources on dynamic areas while ignoring static regions, thereby improving computational efficiency. The frame differencing process can have such as, for example, absolute differencing, squared differencing, normalized cross-correlation or the like that can measure depending on the specific motion detection requirements and noise characteristics of the input video.

In certain embodiments, temporal filtering can apply smoothing operations across the time dimension to reduce flickering artifacts and improve temporal consistency of the processed video frames. The temporal filter can have such as, for example, exponential smoothing, moving average filtering, Kalman filtering, particle filtering to maintain smooth transitions while preserving important temporal features or the like. The temporal filtering parameters can be dynamically adjusted based on detected motion levels and scene complexity to balance noise reduction with motion preservation. Edge enhancement algorithms accentuate boundary features within video frames to improve the performance of subsequent facial detection algorithms. The system can implement various edge detection operators such as, for example, Sobel, Prewitt, Roberts, Laplacian of Gaussian (LoG), Canny edge detectors, or the like with parameters automatically tuned based on image characteristics and processing requirements. The enhanced edge information provides clearer facial boundaries and feature definitions that improve the accuracy of facial landmark detection and sentiment analysis.

In embodiments, the pre-processing module can be implemented using specialized hardware acceleration such as, for example, Graphics Processing Units (GPUs) for parallel processing of video frames, Digital Signal Processors (DSPs) for efficient algorithm execution, or dedicated Application-Specific Integrated Circuits (ASICs) optimized for video processing operations or the like. The hardware can have real-time processing of high-resolution video streams while maintaining low power consumption and minimal processing latency. Software implementations utilize optimized libraries and parallel processing frameworks to achieve maximum performance on general-purpose computing platforms. Memory management systems can handle video frame buffers and intermediate processing results through techniques including such as, for example, ring buffers for continuous video processing, memory pooling to reduce allocation overhead, and cache optimization to maximize data throughput. The memory architecture can be designed to support multiple concurrent video streams while maintaining processing performance and system stability under varying computational loads.

At step 18 the video can be redefined wherein the data involves transforming at least one raw video frames into a format or representation that is more suitable for analysis and processing by the machine learning modules. The raw video frames can transform raw video data into a format that is more structured and useful for a facial and sentiment detection analysis. The process includes enhancing the quality of the data, reducing noise, extracting relevant features, and preparing the date for the machine learning modules. The frame extraction can break down the continuous video stream into individual frame for independent processing wherein motion can be captured and dynamic changes over time can be analyzed.

At step 20, the redefined video data can be transferred into a facial detection module which can employ a convolutional neural network (“CNN”) to identify and localize human facial regions within the video frames. The facial detection module can identify and localize human faces within video frames by using such as, for example, an input frame processing, CNN, bounding box regressing, non-maximum suppression (“NMS”), output generation or the like. The input frame processing can prepare the raw input frames for the CNN by performing operations such as image resizing to standardize input dimensions, pixel normalization to ensure consistent value ranges, and color space conversion if necessary. The preprocessing may also include data augmentation techniques such as rotation, scaling, or brightness adjustment to improve the robustness of the detection system. The CNN can detect, at step 22, and localize faces within the processed frames at step 24. The CNN can be trained to recognize patterns and features specific to human faces through multiple convolutional layers that extract hierarchical features, starting from low-level edge detection to high-level facial structure recognition.

The network architecture can have such as, for example, pooling layers for dimensionality reduction, activation functions such as ReLU for non-linearity, and fully connected layers for classification decisions. The bounding box regression can refine the location and size of the detected faces by adjusting the bounding boxes predicted by the CNN through coordinate regression techniques that optimize the precision of facial boundary detection. The NMS can eliminate redundant and overlapping bounding boxes to ensure that each detected face is represented by a single bounding box by calculating intersection-over-union (IoU) scores and suppressing boxes with lower confidence scores that significantly overlap with higher confidence detections. The output generation can provide the final list of detected faces, each represented by a refined bounding box with associated confidence scores, pixel coordinates, and metadata such as face size and orientation that can be utilized by subsequent processing modules for further analysis.

At step 26, a sentiment classification module classifies the extracted features to determine sentiments and to classify them into predefined emotional categories. The sentiment classification module employs a deep learning model configured to classify facial expressions into predefined categories. These predefined categories can be, such as, for example, happiness, sadness, anger, disgust, surprise, fear, neutrality, embarrassment, contempt, frustration, or the like. The deep learning model includes a CNN or recurrent neural network (“RNN”) trained with sentiment-specific datasets which can allow the system to accurately classify a wide range of facial expressions. The sentiment classification module can process the localized facial regions identified by the facial detection module to extract relevant features that are indicative of various emotions. The sentiment classification module can classify the extracted features to determine sentiments.

The deep learning model can include recurrent neural networks and long short-term memory networks for analyzing temporal sequences of facial expressions which can allow the system to take into account the temporal dynamics of facial expressions, which can provide additional information about the sentiments being expressed. An output generation can generate and format the output of the sentiment classification module which can typically provide emotion labels for each detected face by interpreting predictions which can convert the model's raw outputs into human-readable emotion labels and then associate with faces which can map the classified emotions to the detected faces in the original frame. The sentiment classification module can integrate an Action Unit (AU) detection based on the Facial Action Coding System. The use of the facial action coding system can be used to identify specific facial muscle movements, which are AU, associated to different emotions. The AU detection utilizes algorithms such as, for example, OpenFace, Dlib, Haar Cascades, DeepFace, FaceNet, or the like for detailed sentiment inference which can provide a fine-grained analysis of facial expressions improving the accuracy of sentiment detection.

At step 28, a feature extraction module can extract geometric and appearance features from the localized facial regions. The geometric features can include aspect ratios of facial landmarks and distances between specific facial landmarks. The aspect ratios can include such as, for example, eye aspect ratio, mouth aspect ratio, specific facial landmarks include the inter-pupillary distance or the like. The geometric features can provide valuable information about the structure and proportions of the face, which can be used to infer sentiments. The appearance features include such as, for example, analysis of wrinkles, furrows, cheeks, eyes, lip curvature, descriptors for texture representation or the like. The descriptors for texture representation can include Local Binary Patterns which can be descriptors that summarize the local texture of the image. The appearance features provide information about the surface properties of the face, which can also be used to infer sentiments.

In certain embodiments, the geometric features can include facial asymmetry measurements, eyebrow positioning relative to the eye region, nostril flare ratios, and chin-to-forehead proportional distances. The feature extraction module can compute dynamic geometric features such as the rate of change in facial landmark positions over consecutive frames for video-based sentiment analysis. The appearance features can further encompass such as, for example, skin tone variations, under-eye region intensity analysis, forehead tension patterns, nasolabial fold depth measurements or the like. Advanced texture descriptors such as Histogram of Oriented Gradients (HOG), Gabor filters, and Scale-Invariant Feature Transform (SIFT) keypoints can be employed to capture fine-grained facial surface characteristics. The extracted features can be normalized using z-score standardization or min-max scaling to ensure consistent feature magnitude across different facial images and lighting conditions, thereby improving the robustness of subsequent sentiment classification algorithms.

At step 30 a sentiment analysis can be performed and an assignment made for each appearance feature. The sentiment analysis of the facial recognition can classify the facial expressions to determine the underlying emotion or sentiment. The sentiment analysis can leverage various features extracted from facial regions and uses a trained machine learning or deep learning model to assign an emotion label to each detected face. The sentiment analysis can such as, for example, normalize features, predict models, map emotions, integrate the emotion labels. Feature normalization can standardize the extracted features to ensure consistency in model predictions wherein the model predictions can be used to train the sentiment classification model to predict the emotion based on the extracted and normalized features. Emotional mapping can convert the model's raw output into human-readable emotion labels and then integrate the emotional labels with the detected faces and prepare for further use such as displaying sending date to an API, at step 34.

The sentiment classification model can utilize ensemble methods combining multiple algorithms such as, for example, Support Vector Machines (SVM), Random Forest, Convolutional Neural Networks (CNN), or the like to enhance prediction accuracy and reduce classification errors. The model can implement confidence scoring mechanisms that assign probability values to each predicted emotion, enabling the system to identify uncertain classifications and potentially trigger manual review processes. Multi-class emotion recognition can be performed to distinguish between primary emotions including happiness, sadness, anger, fear, surprise, disgust, and neutral states, with additional capability to detect complex emotional states through weighted combinations of primary emotions. The system can have temporal analysis for video sequences, tracking emotion transitions over time and applying smoothing algorithms to reduce frame-to-frame prediction inconsistencies. Real-time processing optimizations can include feature caching, model quantization, and parallel processing techniques to maintain low latency performance. The sentiment analysis results can be formatted into structured data outputs including such as, for example, emotion labels, confidence scores, bounding box coordinates, timestamp information, or the like for seamless integration with downstream applications and analytical systems.

In embodiments, at step 32 sentiment decision and probability score is given, wherein the sentiment decision can set the final classification of the facial expression into one of the predefined emotion categories and the probability score indicates the confidence level of the model in its classification decision. The sentiment decision and probability score can comprise a model prediction used to train the machine learning or deep learning model to analyze the extracted features and predict the sentiment. The probability score calculation can calculate the probability score for each possible emotion class based on the model's output and then a final sentiment classification is given based on the highest probability score and then the final sentiment can be returned to the API, at step 34.

In certain embodiments, the sentiment decision process can implement multi-layered classification logic incorporating threshold-based filtering, wherein probability scores below a predetermined confidence threshold can trigger alternative processing pathways such as secondary model validation or manual review flagging. The probability score calculation can utilize softmax activation functions to convert raw neural network outputs into normalized probability distributions across all emotion classes, ensuring that the sum of all probability scores equals unity. Advanced probability calibration techniques such as, for example, Platt scaling or isotonic regression can be applied to improve the reliability of confidence estimates, particularly for edge cases where multiple emotions exhibit similar probability values. The system can implement hierarchical classification strategies that first distinguish between positive, negative, and neutral sentiment categories before performing fine-grained emotion classification within each category.

Dynamic threshold adjustment mechanisms can be used to optimize classification performance based on real-time accuracy metrics and user feedback, allowing the system to adapt to varying image quality conditions and demographic variations. The probability scoring can incorporate uncertainty quantification methods such as Monte Carlo dropout or ensemble variance to provide additional confidence measures beyond simple probability values. Multi-modal fusion techniques can combine facial expression probabilities with contextual information such as body language, voice tone, or environmental factors when available, resulting in more robust sentiment decisions. The final classification process can include post-processing filters that apply temporal smoothing for video sequences, demographic bias correction algorithms, and outlier detection mechanisms to ensure consistent and fair sentiment analysis across diverse user populations before transmitting the results to the API endpoint.

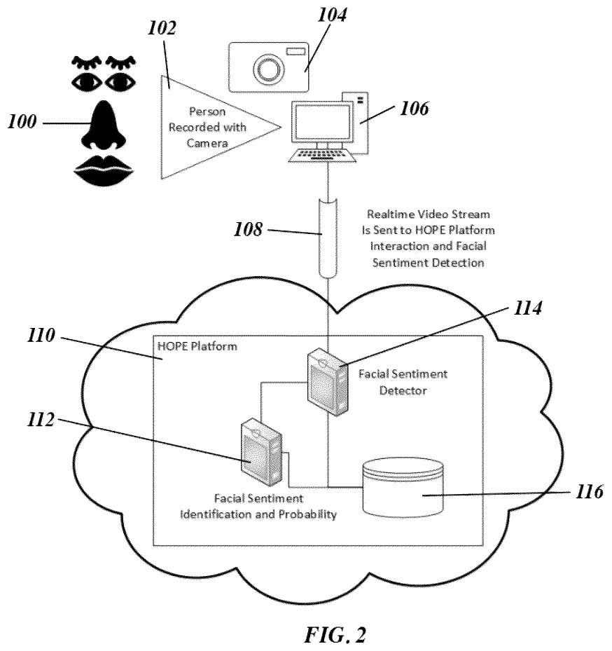

Referring to FIG. 2, an individual's face with a sentiment is shown at 100. The person is then being recorded 102 by the video source 104 which can be coupled to a computing system 106. A real-time video stream is sent to the metahuman platform where interaction and facial sentiment is detected, at 108. The metahuman platform 110 can comprise of the facial sentiment detector 114 and a facial sentiment identification and probability as described above and returned to an API for the metahuman to properly respond to the sentiment seen and given by the individual talking with the metahuman.

The method for real-time facial and sentiment detection involves receiving real-time video input from one or more video sources, pre-processing the video frames by performing scaling, color space conversion, and background subtraction, detecting and localizing human faces within the video frames using a convolutional neural network, extracting geometric and appearance features from the localized facial regions, and classifying the extracted features to determine sentiments. The method also includes the step of integrating the sentiment recognition results into third-party applications via an API. This allows the sentiment recognition capabilities of the system to be leveraged in a wide range of applications. In conclusion, the present invention provides a system and method for real-time facial and sentiment detection. The system and method are capable of handling real-time video input from a variety of sources, accurately detecting and localizing human faces within video frames, extracting geometric and appearance features from the localized facial regions, and classifying the extracted features to determine sentiments. The system and method also provide API integration capabilities, allowing the sentiment recognition results to be utilized in third-party applications.

The real-time facial sentiment analysis system described in this patent application offers significant practical applications across customer service, education, and healthcare sectors by providing automated emotional intelligence capabilities that enhance human interactions and improve service delivery.

In customer service environments, this technology enables systems to automatically detect and respond to customer emotional states during video calls, chat sessions, or in-person encounters. When a customer contacts support, the system continuously monitors their facial expressions through webcam feeds or security cameras, automatically identifying signs of frustration, confusion, satisfaction, or anger in real-time. This emotional intelligence allows customer service avatars to be aware of when a customer becomes upset, enabling them to adjust their approach, escalate issues appropriately, or provide additional assistance before situations deteriorate. The system can also automatically route customers to specialized representatives or algorithm branches based on detected emotional states, ensuring that highly frustrated customers receive immediate attention while satisfied customers can be efficiently processed through standard channels. Additionally, the technology provides valuable analytics for service quality management by tracking emotional trends across customer interactions, identifying common pain points that consistently trigger negative emotions, and measuring the effectiveness of different service approaches in maintaining positive customer sentiment throughout the interaction process.

Educational applications of this facial sentiment analysis technology provide educators with unprecedented insights into student engagement, comprehension, and emotional well-being during instruction. In classroom settings, the system monitors students' facial expressions through existing camera infrastructure, automatically detecting signs of confusion, boredom, excitement, or stress as lessons progress. The system receives real-time feedback about class-wide emotional responses, enabling them to immediately adjust their teaching pace, clarify confusing concepts, or shift to more engaging activities when widespread confusion or disengagement is detected. The technology proves particularly valuable in online learning environments where traditional visual cues are limited, allowing the instruction system to gauge student sentiment through video conferencing platforms and adapt their delivery accordingly. Beyond immediate classroom applications, the system generates detailed analytics about learning patterns, identifying which topics consistently generate confusion or excitement among students, helping educators refine their curricula and teaching methods. The technology also supports personalized learning by tracking individual student emotional responses over time, identifying students who may be struggling emotionally with specific subjects or concepts, and enabling early intervention to provide additional support or alternative learning approaches before academic performance suffers.

Healthcare applications leverage this sentiment analysis technology to enhance patient care, improve treatment outcomes, and support medical staff in delivering more empathetic and effective care. In clinical settings, the system monitors patients' facial expressions during consultations, procedures, or therapy sessions, automatically detecting signs of pain, anxiety, depression, or discomfort that patients might not verbally communicate. This capability proves especially valuable when working with patients who have difficulty expressing themselves verbally, including children, elderly individuals with cognitive impairments, or patients with communication disorders. Healthcare providers receive real-time alerts about changes in patient emotional states, enabling them to adjust treatment approaches, provide additional comfort measures, or investigate underlying concerns that might not otherwise be apparent.

The technology supports mental health treatment by providing objective measurements of patient emotional states over time, helping therapists and psychiatrists track treatment progress, identify emotional patterns, and adjust therapeutic interventions based on quantitative emotional data rather than relying solely on patient self-reporting. In hospital environments, the system monitors patient sentiment continuously, alerting nursing staff when patients experience increased distress or discomfort, enabling more responsive care and potentially identifying medical complications before they become critical. The technology also supports caregiver well-being by monitoring healthcare worker emotional states, identifying signs of burnout, stress, or fatigue that could impact patient care quality, and enabling healthcare administrators to provide appropriate support or schedule adjustments to maintain optimal care standards.

In closing, it is to be understood that although aspects of the present specification are highlighted by referring to specific embodiments, one skilled in the art will readily appreciate that these disclosed embodiments are only illustrative of the principles of the subject matter disclosed herein. Therefore, it should be understood that the disclosed subject matter is in no way limited to a particular methodology, protocol, and/or reagent, etc., described herein. As such, various modifications or changes to or alternative configurations of the disclosed subject matter can be made in accordance with the teachings herein without departing from the spirit of the present specification. Lastly, the terminology used herein is for the purpose of describing particular embodiments only and is not intended to limit the scope of the present disclosure, which is defined solely by the claims. Accordingly, embodiments of the present disclosure are not limited to those precisely as shown and described.

Certain embodiments are described herein, including the best mode known to the inventors for carrying out the methods and devices described herein. Of course, variations on these described embodiments will become apparent to those of ordinary skill in the art upon reading the foregoing description. Accordingly, this disclosure includes all modifications and equivalents of the subject matter recited in the claims appended hereto as permitted by applicable law. Moreover, any combination of the above-described embodiments in all possible variations thereof is encompassed by the disclosure unless otherwise indicated herein or otherwise clearly contradicted by context.

We claim:

1. A method for real-time facial and sentiment detection, the method comprising the acts of:
receiving real-time video input from one or more video sources;
pre-processing the video frames by performing scaling, color space conversion, and background subtraction;
detecting and localizing human faces within the video frames using a convolutional neural network;
extracting geometric and appearance features from the localized facial regions; and
classifying the extracted features to determine sentiments.

2. The method of claim 1, wherein the pre-processing act includes converting RGB color space to grayscale or HSV color space.

3. The method of claim 1, wherein the detecting and localizing act utilizes multi-task cascaded convolutional networks to detect and localize multiple faces within a video frame to detect and localize the human faces.

4. The method of claim 1, wherein the extracting act includes generating facial region coordinates, deriving aspect ratios of facial landmarks and distances between specific facial landmarks.

5. The method of claim 4, wherein the aspect ratios include eye aspect ratio and mouth aspect ratio, and the distances between specific facial landmarks include the inter-pupillary distance.

6. The method of claim 1, wherein the extracting act includes analyzing wrinkles, furrows, and lip curvature, and employing descriptors for texture representation.

7. The method of claim 6, wherein the descriptors for texture representation include Local Binary Patterns.

8. The method of claim 1, wherein the classifying act includes employing a deep learning model to classify facial expressions into predefined categories.

9. The method of claim 8, wherein the deep learning model includes convolutional neural networks trained with sentiment-specific datasets.

10. The method of claim 8, wherein the deep learning model includes recurrent neural networks and long short-term memory networks for analyzing temporal sequences of facial expressions.

11. The method of claim 1, further comprising the act of integrating the sentiment recognition results into third-party applications via an API.

12. The method of claim 1, wherein the classifying act includes performing Action Unit detection based on the Facial Action Coding System.

13. The method of claim 1, further comprising executing matrix operations on pixel data arrays to automatically generate facial region coordinates and confidence probability scores, and applying non-maximum suppression algorithms that calculate intersection-over-union metrics to eliminate detection redundancies.

14. The method of claim 1, further comprising extracting technical feature measurements including geometric calculations of eye aspect ratios and mouth aspect ratios from facial landmark coordinate data, inter-pupillary distance measurements, and Local Binary Pattern texture descriptors computed through pixel neighborhood comparison.

15. The method of claim 1, further comprising addressing temporal consistency challenges by analyzing feature sequences through long short-term memory networks that maintain state information across video frames and apply smoothing algorithms to reduce classification fluctuations.

16. The method of claim 1, further comprising performing multi-algorithm sentiment classification using ensemble methods that combine Support Vector Machine, Random Forest, and convolutional neural network processing with Action Unit detection based on Facial Action Coding System algorithms to generate emotion category classifications with normalized probability scores.

17. The method of claim 1, further comprising wherein extracting act includes computing appearance characteristics comprising wrinkle pattern analysis, furrow depth measurements, and lip curvature parameters to enhance emotion detection accuracy.

18. The method of claim 15, wherein the long short-term memory networks implement frame differencing calculations that determine pixel-wise differences between consecutive frames to identify motion regions and focus processing resources on dynamic facial areas.

19. The method of claim 1, further comprising automatically formatting classification results into structured data formats including emotion labels, confidence scores, coordinate information, and timestamp data for transmission to external applications via API protocols.
